(19) United States
(12) Patent Application Publication
(10) Pub. No.: US 2006/0031674 A1
(43) Pub. Date: Feb. 9, 2006

(54) Encrypting method and encrypting apparatus for image processing apparatus

(75) Inventor: Atsushi Sakurai, Mishima-shi (JP)

Correspondence Address: SoCAL IP LAW GROUP LLP, 310 N. WESTLAKE BLVD. STE 120, WESTLAKE VILLAGE, CA, 91362, US

(73) Assignees: Kabushiki Kaisha Toshiba, Minato-ku (JP); Toshiba Tec Kabushiki Kaisha, Chiyoda-ku (JP)

(21) Appl. No.: 10/914,756

(22) Filed: Aug. 9, 2004

(51) Int. Cl. H04L 9/00

(52) U.S. Cl. 713/166

(57) ABSTRACT

There is disclosed an encrypting apparatus including a main controller. The main controller collectively controls reader 12, read image processing circuit 13, printer 18, print image processing circuit 17, buffer memories 14, 16, encryption device 23, decryption device 24, foreign key detection circuit 47 and control panel 41. An encryption key and level controller sets encryption strength to an arbitrary one level of two or more several levels when the encryption device encrypts the image data.

### BACKGROUND OF THE INVENTION

1. Field of the Invention

The present invention relates to an encrypting method and encrypting apparatus for an image processing apparatus.

2. Description of the Related Art

Conventionally, leakage of confidential data has come to be seen as a problem in a multifunction peripheral (MFP), for example, an apparatus such as a digital copying machine having a data storage function. For this reason, the method of protecting confidential data has attracted special interest. A hard disk drive (HDD) is mainly used to achieve the data storage function. Data prepared for copying, network printout and scanning is stored in the HDD, and browsed and fetched under a relatively free environment. However, official agents and companies possess many documents relevant to personal information and trade secrets. For this reason, these documents should not be easily printed.

Data encryption is desired in most of sections and departments of the official agent and company, and a unit system for carrying out encryption is already operating.

The unit system encrypts all data stored in the HDD at the same level. In this case, key codes for encryption are either held in built-in software of the apparatus or held using a hard key.

The foregoing MFP device is used as a printer in addition to copying. In a printer function, it is possible to set passwords for each print job using a private printout function. In this case, the printout is held, and a user specifies a print queue via a control panel of the apparatus, and thereafter, inputs his password, and thereby, printout is permitted at least.

However, all data stored in the HDD is encrypted; in this case, authentication is required with respect to all users. Official agents, in particular, agents possessing many secret matters require the system described above. In fact, data to be secured is extremely limited in many companies, and most data has not so high secret matters. If the company introduces a system for querying authentication with respect to all users, this is a factor in reducing work efficiency.

In recent years, techniques of illegally decoding ciphers have advanced; for this reason, the encryption strength must be enhanced as measures against illegal techniques. On the other hand, several keys are not allocated to the same machine to achieve data encryption. For this reason, if a cipher key is once known, there is a possibility that all data stored in the machine is decoded.

As described above, the foregoing MFP device is used as a printer in addition to copying. The user sends data to the MFP device from a place remote from the apparatus via a network. There is a possibility that the data content thus sent includes an important document. In this case, the private printout function is used, and thereby, it is possible to temporarily hold the output. However, one password is input, and thereby, access to the print queue is made. If data is not encrypted, the hard disk drive is detached from the apparatus, and thereafter, the data is stolen.

As is evident from the foregoing description, the conventional apparatus does not secure sufficient security with respect to confidential documents. In addition, a cryptosystem using the same key is employed when encrypting data like a copy; in this case, it is difficult to say that sufficient security is given.

### BRIEF SUMMARY OF THE INVENTION

According to an aspect of this invention, it is an object to provide an encrypting method and encrypting apparatus for an image processing apparatus, which have several strength levels for encrypting data.

According to an embodiment of this invention, there is provided an encrypting apparatus for an image processing apparatus, comprising: a reader reading an image; a read image processing circuit processing the read image; a printer carrying out print to media; a print image processing circuit carrying out print image processing for print; a buffer memory used for image data processing; an encryption device encrypting the image data inputted to the buffer memory; a storage device storing the encrypted image data; a decryption device decrypting the encrypted image data; a foreign key detection circuit recognizing a hard key; a control panel including a control panel for carrying out various settings by a user, and for inputting ID and password for taking a procedure for personal authentication; a main controller collectively controlling the foregoing reader, read image processing circuit, printer, print image processing circuit, buffer memory, encryption device, decryption device, foreign key detection circuit and control panel; and an encryption key and level controller setting an encryption strength to arbitrary one level of two or more several levels when the encryption device encrypts the image data.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate presently preferred embodiments of the invention, and together with the general description given above and the detailed description of the embodiments given below, serve to explain the principles of the invention.

FIG. 1 is a block diagram showing the configuration of an image forming apparatus according to an embodiment of the present invention;

FIG. 2A to FIG. 2F is a view showing one display example of a display section on a control panel to explain the operation of the apparatus according to the invention;

FIG. 3A to FIG. 3D is a view showing another display example of a display section on a control panel to explain the operation of the apparatus according to the invention;

FIG. 4A to FIG. 4G is a view showing another display example of a display section on a control panel to explain the operation of the apparatus according to the invention;

FIG. 5A to FIG. 5D is a view showing another display example of a display section on a control panel to explain the operation of the apparatus according to the invention;

FIG. 6 is a flowchart to explain the operation (document scanning) of the apparatus according to the invention;

FIG. 7 is a flowchart to explain another operation (printout) of the apparatus according to the invention;

FIG. 8 is a flowchart to explain another operation (printout from network) of the apparatus according to the invention;

FIG. 9 is a flowchart to explain still another operation (personal authentication data registration) of the apparatus according to the invention;

FIG. 10 is a flowchart to explain still further another operation (personal authentication data collation) of the apparatus according to the invention;

FIG. 11 is a view to explain the generation of an encryption key employed in the apparatus according to the invention:

FIG. 12 is a view to explain another generation of an encryption key employed in the apparatus according to the invention;

FIG. 13 is a view to explain still another generation of an encryption key employed in the apparatus according to the invention; generation of an encryption key employed in the apparatus according to the invention;

FIG. 15 is a table to explain elements for setting encryption level carried out in the apparatus according to the invention;

FIG. 16 is a flowchart to explain another operation of the apparatus according to the invention; and

FIG. 17 is a flowchart to explain still another operation of the apparatus according to the invention.

### DETAILED DESCRIPTION OF THE INVENTION

Hereinafter, embodiments of the present invention will be explained in detail with reference to the attached drawings.

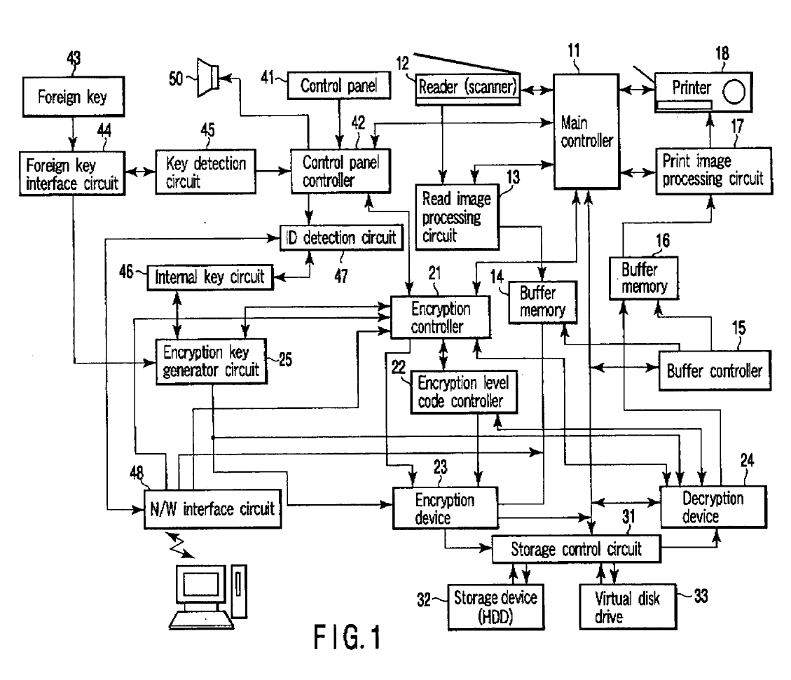

FIG. 1 shows one embodiment of the present invention. In FIG. 1, a reference numeral 11 denotes a main controller, which controls the operation and sequence of each block included in the MFP device (referred to as an image processing apparatus). A reference numeral 12 denotes a reader including a scanner for inputting an image. The image data read by the reader 12 is supplied to a read image processing circuit 13, and digitized there, and thereafter, temporarily stored in a buffer memory 14. A buffer controller 15 controls access and clear to the buffer memory 14. The buffer controller 15 further controls a buffer memory 16. The buffer memory 16 is used for temporarily storing data when the image data is printed. The output of the buffer memory 16 is supplied to a print image processing circuit 17 for digitizing data, and converted into a print image, and thereafter, sent to a printer 18.

When temporarily storing the output of the buffer memory 14 in a storage device (HDD) 32, the apparatus of the present invention can store the output after encrypting it. In order to store the data, a virtual disk drive 33 is provided. The virtual disk drive 33 comprises a volatile memory in order not to leave the data later.

The apparatus is provided with encryption and decryption means for the foregoing encryption. The apparatus is further provided with an encryption key and level control section for controlling these encryption and decryption means. The control section (means) will be explained in detail later.

The output of the buffer memory 14 is input to an encryption device 23, and thereafter, encrypted there. The encrypted data is input to the HDD 32 based on access control of a storage control circuit 31, and then, recorded in a hard disk. The apparatus is provided with the virtual disk drive 33 comprising a volatile memory. The virtual disk drive 33 can store the encrypted data.

When the image data corresponding to the stored data is printed, data recorded in the hard disk or data of the volatile memory is read, and thereafter, sent to a decryption device 24 via the storage control circuit 31. The data decrypted by the decryption device 24 is supplied to the buffer memory 16, and then, transferred to the print process. The serial copy operation ends, and thereafter, the buffer controller 16 clears data stored in the buffer memories 14 and 16 so that the image data is erased.

Encryption controller 21, encryption level code controller 22 and encryption key generator circuit 25 are provided relative to the foregoing encryption and decryption devices 23 and 24.

The encryption controller 21 sets an encryption level code (for several encryption levels) of the encryption level code controller 22. In this case, the encryption controller 21 sets the code in accordance with the number of encryption keys of the encryption key generator circuit 25. The encryption controller 21 and the encryption level code controller 22 control the encryption device 23, and set the encryption level. Further, The encryption controller 21 and the encryption level code controller 22 control the decryption device 24, and set the decryption level (decoding level) corresponding to the encryption level. Keys of the encryption key generator circuit 25 are used for the foregoing encryption and decryption.

A reference numeral 41 denotes a control panel for operating the apparatus by the user. For example, the control panel 41 is provided with liquid crystal display, touch panel input section and operation buttons. A control panel controller 42 controls the control panel 41, and reads data input from the control panel 41. The control panel controller 42 is connected with a speaker 50 (or beeper), and guides the operation procedure.

A reference numeral 43 denotes a foreign key. When the foreign key 43 is loaded, a key detection circuit 45 detects the foreign key 43 via a foreign key interface circuit 44. The control panel controller 42 captures loading information of the foreign key. The encryption key generator circuit 25 captures the foreign key.

A reference numeral 46 denotes an internal key circuit. The internal key of the internal key circuit 46 is captured in the encryption key generator circuit 25. ID of the internal key is supplied to an ID detection circuit 47, and collated with ID inputted from the control panel 41 by the user. The ID detection circuit 47 makes collation of ID captured via a network interface circuit 48 with ID held in the internal key circuit 46. The collation result is display on a display section on the control panel 41 according to the control of the control panel controller 42.

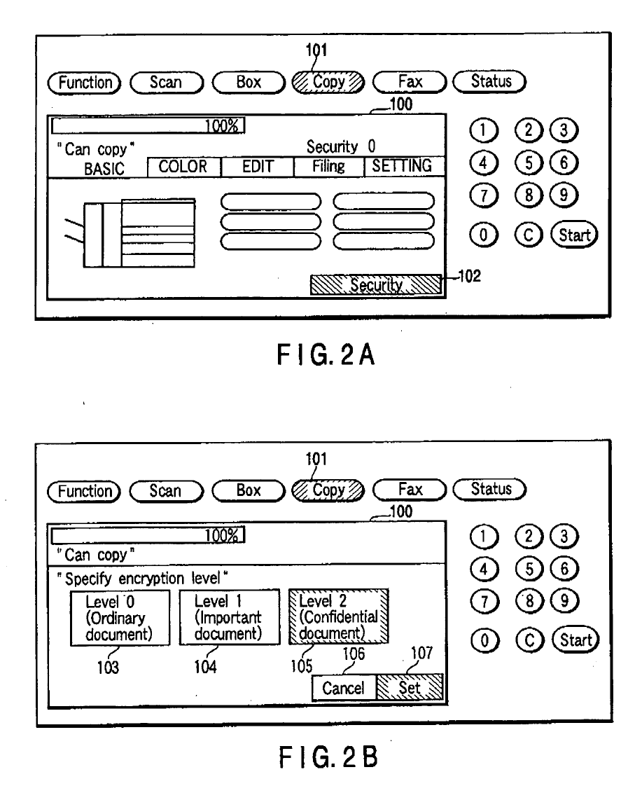

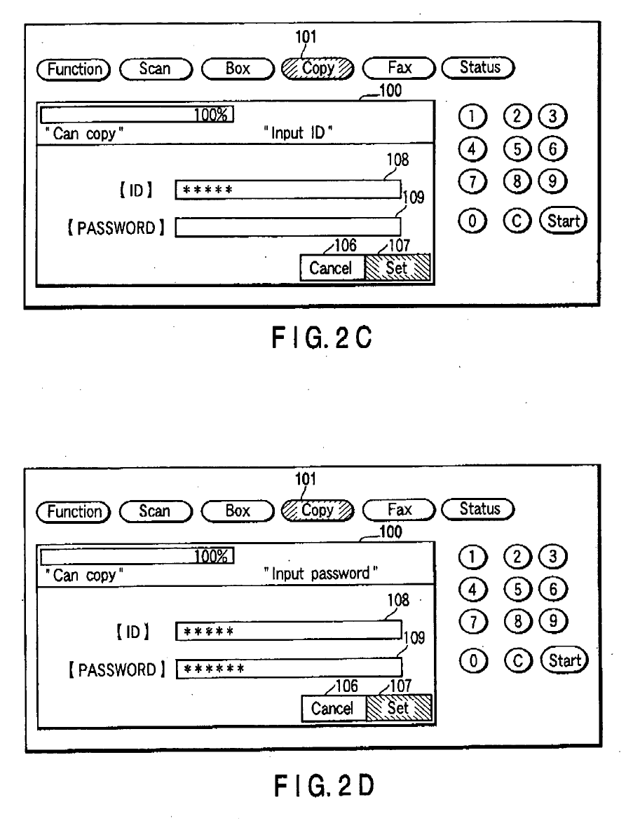

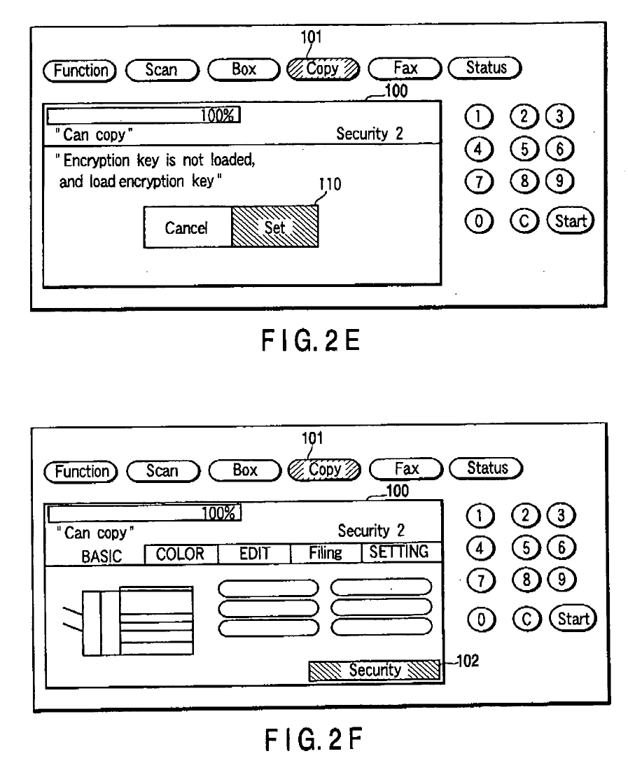

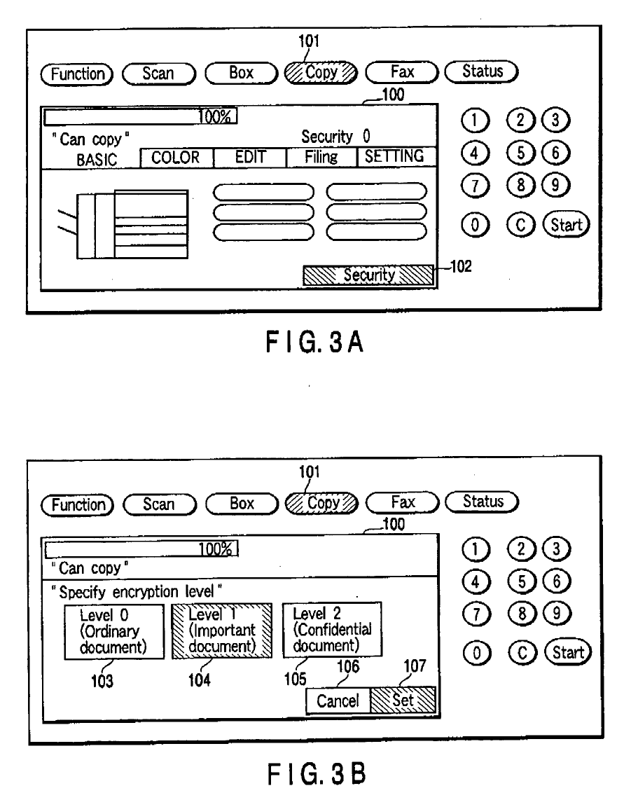

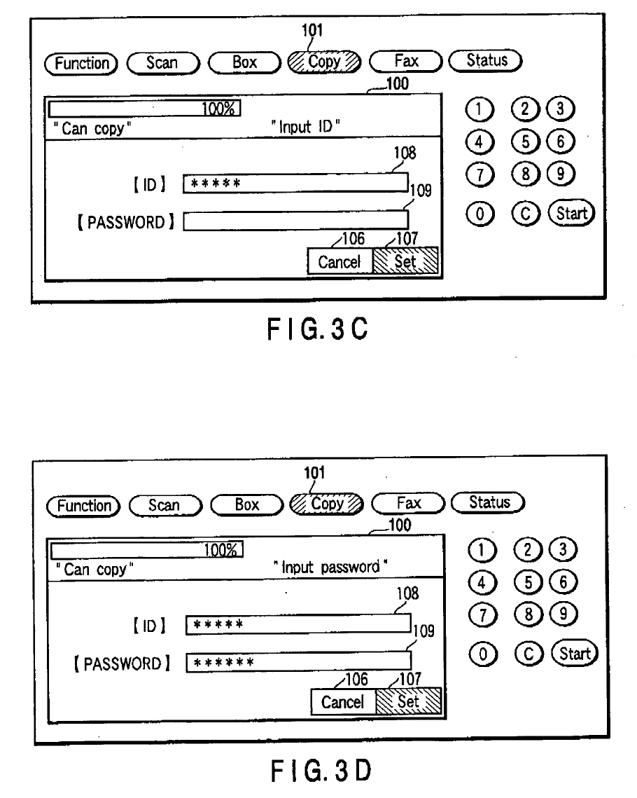

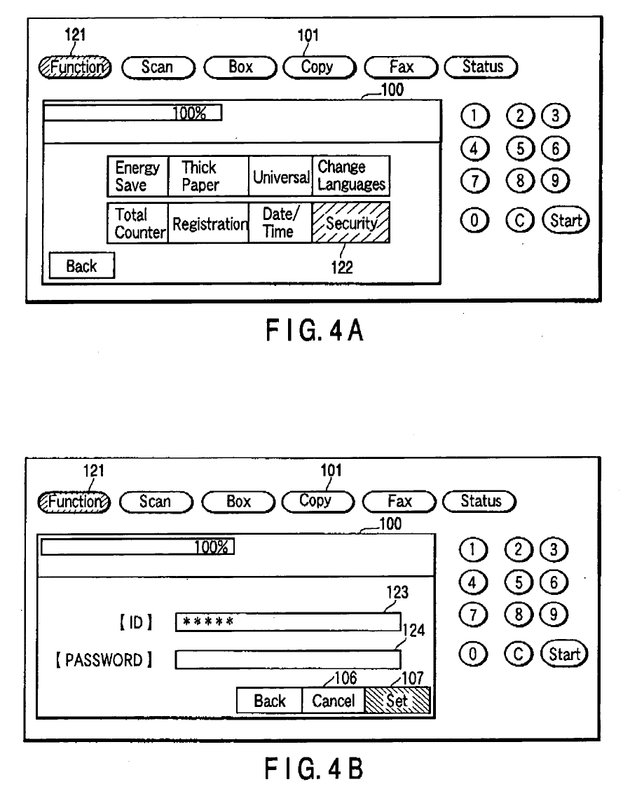

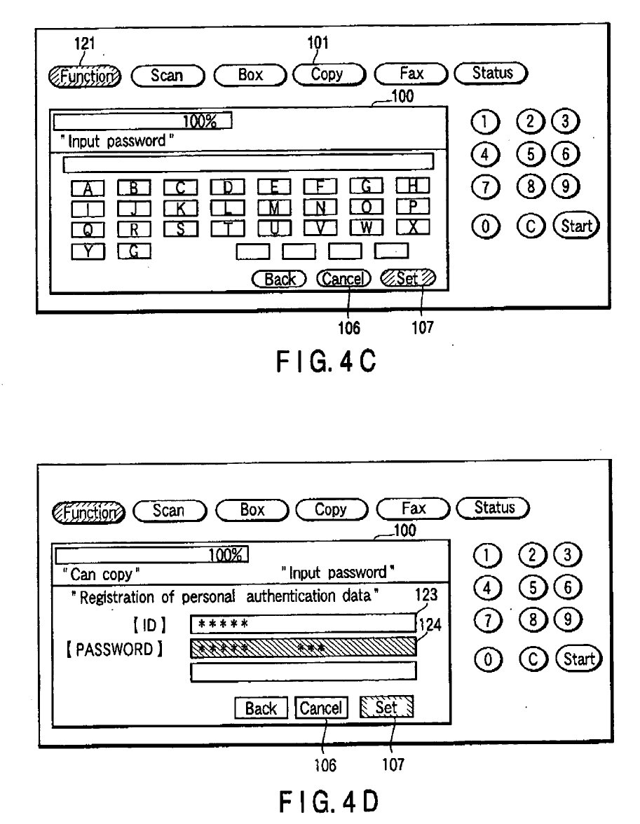

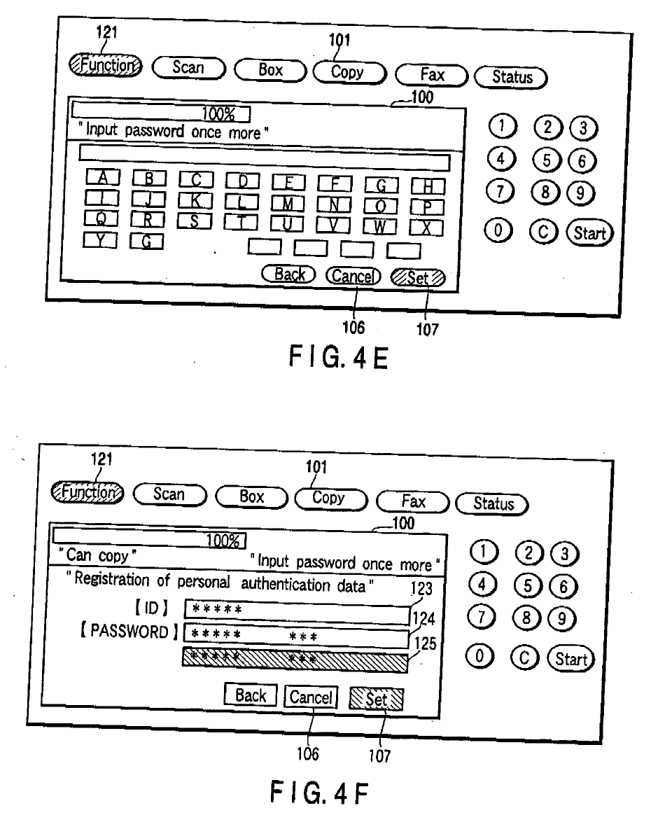

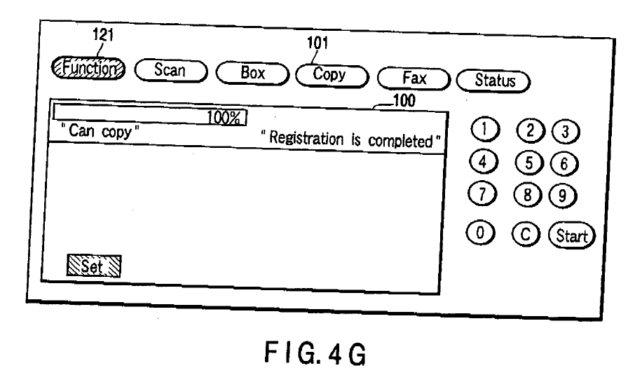

The operation procedures of the apparatus will be explained below. The operation procedures will be explain below with reference to FIG. 2A to FIG. 2F, FIG. 3A to FIG. 3D and FIG. 4A to FIG. 4G showing various display examples on the control panel 41.

[Case of Making a Copy]

The user selects a copy mode from the control panel 41 (FIG. 2A, FIG. 3A). FIG. 2A to FIG. 2F shows a display example (graphical user interface [GUI]) on the control panel 41 when the user makes a copy at encryption level 2. FIG. 3A to FIG. 3D shows a display example on the control panel 41 when the user makes a copy at encryption level 1. A reference numeral 100 denotes a liquid crystal display area provided with a touch panel. The periphery of the display area 100 is provided with function buttons and a numeric keypad.

When making a copy, the user selects a “Copy” button 101. When wishing to achieve encryption, the user pushes on a “security” button 102. The screen display changes into the content shown FIG. 2B, that is, a request screen for setting encryption level is displayed. More specifically, a message “specify encryption level” is displayed, and simultaneously, level 0 button 103, level 1 button 104 and level 2 button 105 are displayed thereon. In addition, “cancel” and “set” buttons 106 and 107 are displayed. Now, the user selects the level 2 (strongest encryption level) button 105, and then, pushes the “set” button. As illustrated in FIG. 2C, a message “Input (your) ID” is displayed, and simultaneously, ID and password input sections 108 and 109 are displayed.

The user inputs his own ID using the numeric keypad, and then, pushes the “set” button. As depicted in FIG. 2D, a message “Input password” is displayed. The user inputs password, and then, pushes the “set” button. In this case, if the foreign key 43 is not loaded, a message “Encryption key is not loaded, and load encryption key” is displayed as seen from FIG. 2E. When the user loads the foreign key 43 and touches a “load” button 110, the display screen returns to the initial screen as shown in FIG. 2F, and a display “security 2” indicative that the current status is encryption level 2 is obtained. By doing so, a copy according to the encryption level 2 is possible.

After JOB ends, the cipher key used for encryption held in the encryption key generator circuit 25 is abandoned by depressing a reset button or by auto-clear timer. If the foreign key is loaded, the following procedure is taken in order to prevent the user from forgetting to remove (undo) the foreign key. More specifically, a message for urging the user to remove the foreign key is displayed on the display screen, and simultaneously, a warning is given to the user via the speaker 50.

The warning of preventing the user from forgetting to remove the foreign key may be given at the timing when the cipher key is abandoned in auto-clear or a check of the foreign key is made.

FIG. 3A to FIG. 3D shows the operation procedure when setting encryption level 1 and its display examples on the control panel 41. FIG. 3A shows the same display state as shown in FIG. 2A, and thus, a state or encryption level 0 is given while the message “security 0” is displayed. When the user selects the “Copy” button 101 and pushes the “security” button 102, a screen shown in FIG. 3B is obtained.

More specifically, a message “specify encryption level” is displayed, and simultaneously, level 0 to 2 buttons 103 to 105 are displayed thereon. In addition, “cancel” and “set” buttons 106 and 107 are displayed. The user selects the level 1 button 104 and pushes the “set” button. As seen from FIG. 3C, a message “Input ID” is displayed, and simultaneously, ID and password input sections 108 and 109 are displayed.

The user inputs his own ID using the numeric keypad, and then, pushes the “set” button. As depicted in FIG. 3D, a message “Input (your) password” is displayed. The user inputs password, and then, pushes the “set” button. By doing so, a copy function according to the encryption level 1 is set. Thereafter, the display screen returns to the state of FIG. 3A; in this case, a message “security 1” is displayed thereon.

For example, the user wishes to hold the image data read by the reader 12 in the apparatus in copy, and to require encryption. The procedure described above is taken based on encryption level 2 only; in this case, it is impossible to select “level 1”. When the virtual disk drive 33 is used to save the image data in the apparatus, the data content is erased if power breakdown occurs. For this reason, HDD is used when selecting the save function. However, there is a need of enhancing the encryption level considering the case where someone intentionally fetches data from the HDD. For this reason, encryption is carried out based on “level 2” only. In the case of “level 0” of using no encryption, the copy operation is carried out using the HDD as usual without using the virtual disk drive 33.

FIG. 4A to FIG. 4G shows a display example on the control panel 41 when the user previously registers personal authentication data comprising the foregoing ID and password. If the user wishes to register personal authentication data, the user pushes a “Function” button 121 as shown in FIG. 4A. In this case, icons showing various functions included in the apparatus and characters representing these functions are displayed. Although these icons are not shown, the following items are given as the characters. For example, “Energy Save”, “Thick Paper”, “Universal”, “Change Language”, “Total Counter”, “Registration”, “Date/time” and “Security”. Now, since the user wishes to register personal authentication data relevant to security, the user selects and pushes a “Security” icon button 122.

The display screen changes into a screen shown in FIG. 4B. In the screen of FIG. 4B, ID input is required. When the user pushes the “set” button 107 after inputting ID, a message “Input password” is displayed while character keys for inputting the ID is displayed, as seen from FIG. 4C. When the user inputs password and pushes the “set” button 107, a display section 124 indicative that the first-time password is inputted is displayed as depicted in FIG. 4D. When the “set” button 107 is depressed, a message “Input password once more” is displayed as shown in FIG. 4E while character keys for inputting password. When the user again inputs password and pushes the “set” button 107, a display section 125 indicative that the second-time password is input is displayed as depicted in FIG. 4F. When the user pushes the “set” button 107, a message “Registration is completed” is displayed as illustrated in FIG. 4G.

In the screen of FIG. 4F, a message for urging the user to input password one more is displayed or a voice message may be given in the following cases. One is the case where the second-time input password is different from the first-time input password. Another is the case where illegal password is input. Another is the case where the input ID number is already used.

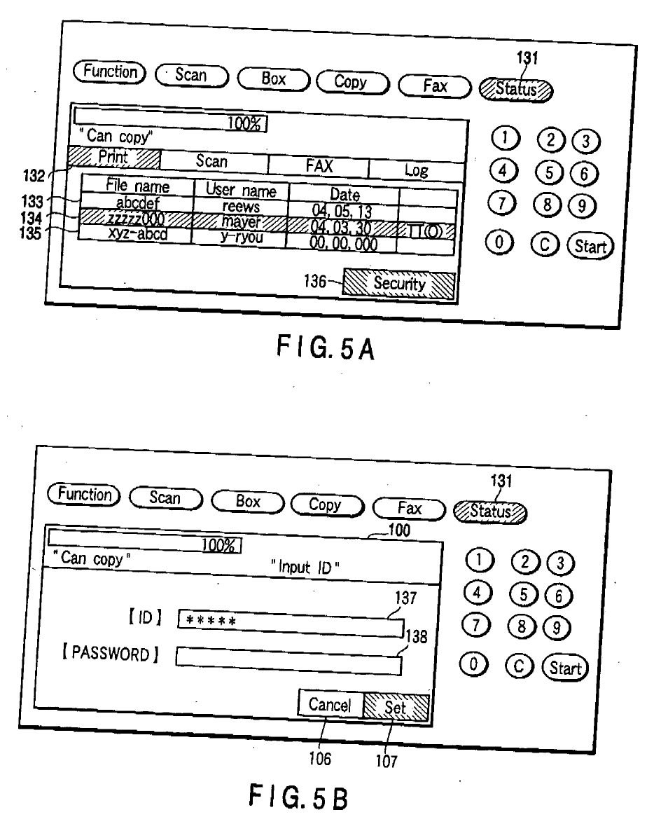

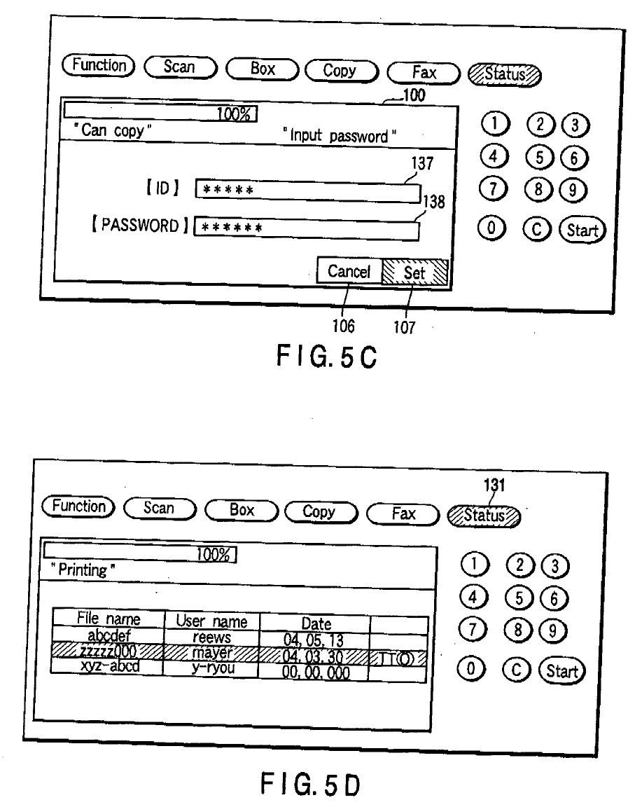

FIG. 5A to FIG. 5D shows a display example on the control panel 41 when data sent via network is stored in the hard disk or virtual disk. In particular, the display example shows the method of specifying a job.

The user pushes a “Status” button 131 as the operation button. A mark is given to a printout display section 132 is marked. A data list stored in the hard disk or virtual disk is displayed as a table in the order of file name, user name and stored data. From the table, it can be seen that files 133 to 135 are stored, The columns displayed by the slant line (by key icon [not shown]) show that the data is encrypted.

Now, the file 134 (encrypted) is selected using a cursor, and a “security” display section 136 is pushed. A message “Input ID” is displayed as shown in FIG. 5B. When the user inputs ID to an ID input section 137 and pushes the “set” button 107, a message “Input password” is displayed. When the user inputs password to a password input section 138 and pushes the “set” button 107, a display screen shown in FIG. 5D is given, and a message “printing” is obtained.

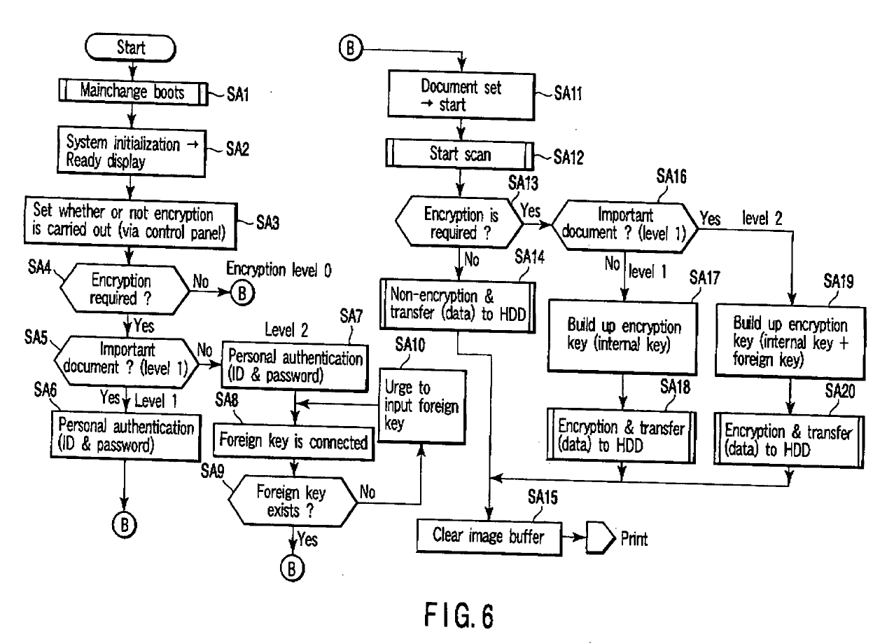

FIG. 6 shows a flowchart to explain the operation when document is read (scanned) in the apparatus of the present invention. The apparatus powers on, and thereafter, when the main controller and others are powered, the system is initialized; whereupon the display shown in FIG. 2A is obtained on the control panel 41 (step SA1-SA3). In the display state, it is determined whether or not encryption is carried out based on user's choice (step SA4). If encryption is carried out, selection of level 1 or level 2 is made in step SA5. If the level 1 is selected, the procedure for personal authentication is taken (step SA6), and thereafter, the process flow transfers to step SA11 for document set→start. If the level 2 is selected, the procedure for personal authentication is taken (step SA7), and it is determined whether or not a foreign key is connected (step SA8, SA9). If the foreign key is not connected, the connection of the foreign key is urged (step SA10). When the foreign key is connected, the process flow transfers to step SA11.

When the document is set and the document read operation starts, scan is started (step SA12) Then, it is determined whether or not encryption is necessary with respect to the read image data (step SA13). If encryption is unnecessary (step SA14), the image data is transferred to the hard disk drive 32 without being encrypted. After the image data is transferred, the buffer memory 14 is cleared.

If it is determined in step SA13 that encryption is necessary, it is determined whether the encryption level is level 1 or level 2 (step SA16). If it is determined that the encryption level is level 1, an encryption key using an internal key is built up (step SA17). Then, encryption is carried out, and then, the image data is transferred to the hard disk drive (step SA18). If it is determined in step SA16 that the encryption level is level 2, an encryption key using the internal and foreign keys is built up (step SA19). Then, encryption is carried out using the encryption key, and then, the image data is transferred to the hard disk drive (step SA20).

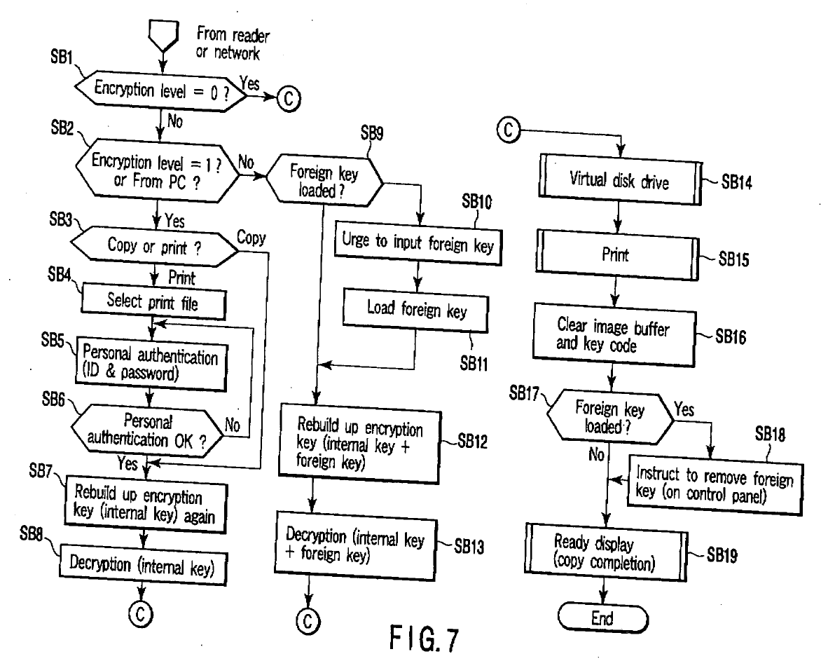

FIG. 7 is a flowchart to explain the operation when image data by network or reader 12 is printed. The image data read by the reader 12 is temporarily stored in the virtual disk drive 33 or hard disk drive 32. FIG. 7 shows the flow from the state that the image data is read.

Based on the content of management data of the management table (e.g., described in FIG. 5A to FIG. 5D), it is determined whether or not the file to be now printed is encrypted. If the file is encrypted, it is determined which the encryption level is level 0, 1 or 2 (step SB1, SB2). If the encryption level is level 0, the file data is sent to a print path via the hard disk drive without taking the procedure relevant to encryption. Then, it is determined whether the file is the encryption level 1 or data sent from a personal computer (step SB2). If the file is the encryption level 1 and signal sent from a personal computer, it is determined whether copy or printout is carried out (step SB3). If the printout is carried out, the operation described in FIG. 5A to FIG. 5D is carried out. More specifically, the file to be printed out is selected (step SB4), and the procedure for personal authentication is taken (step SB5, SB6). The procedure for personal authentication is completed, and thereafter, an encryption key is rebuilt up using the internal key to decrypt the encrypted data (step SB7, SB8). The decrypted data is output to the print path.

If it is determined in step SB2 that the object data is neither encryption level 1 nor signal sent from the personal computer, it is determined whether or not the foreign key is loaded (step SB9). If the foreign key is not loaded, it is urged to load the foreign key (step SB10). Then, when the foreign key is loaded (step SB11), an encryption key is rebuilt up. In this case, the procedure is taken based on the encryption level 2, and thus, the encryption key is rebuilt up using the internal and foreign keys. Decryption is carried out using the encryption key (step SB13). The decrypted data is sent to the print image processing circuit 17 via the virtual disk and the buffer memory (step SB14, SB15).

Printing (step SB15) is completed, and thereafter, the virtual disk (volatile memory) and the buffer memory 16 are cleared. Then, it is determined whether or not the foreign key is loaded, If the foreign key is loaded, a warning display (or voice warning) for removing the foreign key is given (step SB16, SB17). When the cancellation of the foreign key is completed, a copy completion display is obtained while a “Ready” display state is given (step SB19).

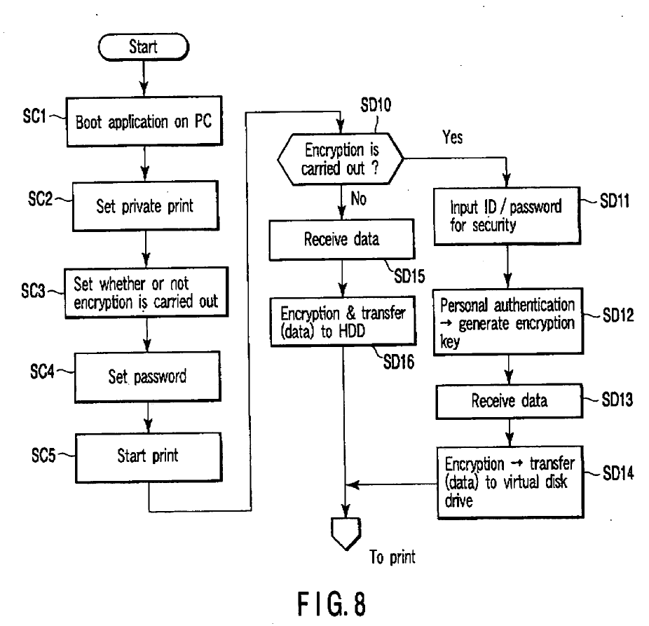

FIG. 8 is a flowchart to explain the operation of processing data from a personal computer (PC). Since information on encryption and ID/password is first sent before processing data from the PC, the information is confirmed (step SD10). If encryption is carried out, the procedure for personal authentication is taken based on ID/password (step SD11), and thereafter, an internal encryption key is prepared (step SD12). The sent data is encrypted using the prepared encryption key (step SD13), and thereafter, stored in the virtual disk drive (step SD14).

The encrypted print data is not printed at once, and the print job is in a pending state. The user selects a necessary job (file) via the control panel of the machine (apparatus), and instructs the print. When the print is carried out, the user is urged to input ID/password. When the input is completed, the procedure for personal authentication is taken, and an encryption key is again prepared to decrypt the data, and thereafter, the decrypted image data is printed. If it is determined in step SD10 that the data is not encrypted, the data is received, and transferred to the print process via the virtual disk drive without encrypting it (step SD15, SD16). The print is completed, and thereafter, the data stored in the virtual disk drive and the buffer memory are cleared in the same manner as described in the copy.

Steps SC1 to SC5 are procedures on the personal computer (PC) side. More specifically, application boots (step SC1), and private print processing is set (step SC2). Then, it is determined whether or not encryption is carried out (step SC3), and password is set (step SC4), and thereafter, print start is instructed (step SC5).

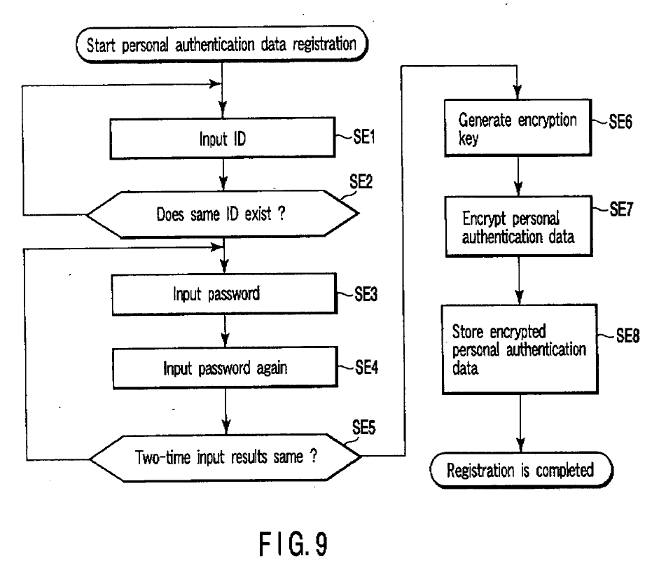

FIG. 9 is a flowchart to explain the operation of registering personal authentication data. GUI for registering personal authentication data has been described in FIG. 4A to FIG. 4G. In brief, when the procedure for registration starts, ID is input (step SE1). If the same ID exists, the input of different ID is again required (step sE2). When the input of ID is completed, the input of password is required (step SE3). The input of password is again required (step SE4). If the foregoing two-time input results are the same, an encryption key is prepared (step SE5, SE6). The personal authentication data (set of ID and password) is encrypted using the encryption key generated by the encryption key generator circuit 25 (step SE7), and saved in the internal key circuit 46 (step SF8). The procedures described above are taken, and thereby, the registration of the personal authentication data is completed.

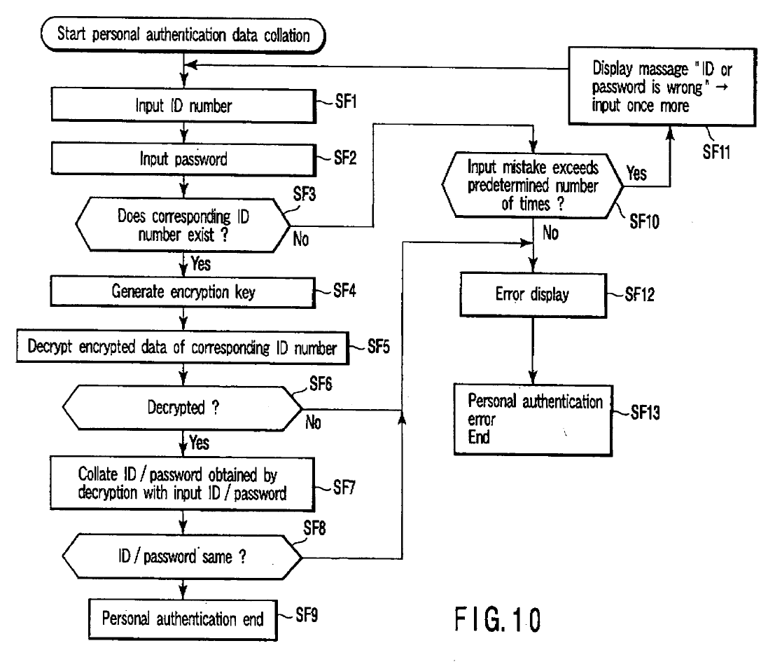

FIG. 10 is a flowchart to explain the operation of making collation of the personal authentication data thus registered. The personal authentication data inputted in the registration is encrypted using the encryption key generated from the authentication data by the encryption key generator circuit 25, and thereafter, held in the internal key circuit 46.

The procedure for personal authentication is taken in the following manner. First, ID and password are input via the control panel 41 (step SF1, SF2). If the corresponding ID exists (step SF3), the encryption key generator circuit 25 generates an encryption key (step SF4). Encrypted data of the ID inputted via the control panel 41 is fetched from data held in the internal key circuit 46, and thereafter, decrypted using the encryption key generated before (step SF5). ID and password obtained by decryption is collated with the input ID and password (step SF7), and thereafter, it is determined whether or not they are the same (step SF8). If these ID and password are the same, the personal authentication ends (step SF9). If the ID corresponding to the ID input is not saved in step SF3, the user is urged to again input ID or password (step SF10, SF11). In this case, if an input mistake exceeds a predetermined number of times, an error display is given, and then, the procedure for personal authentication ends (is stopped?) (step SF12, SF13).

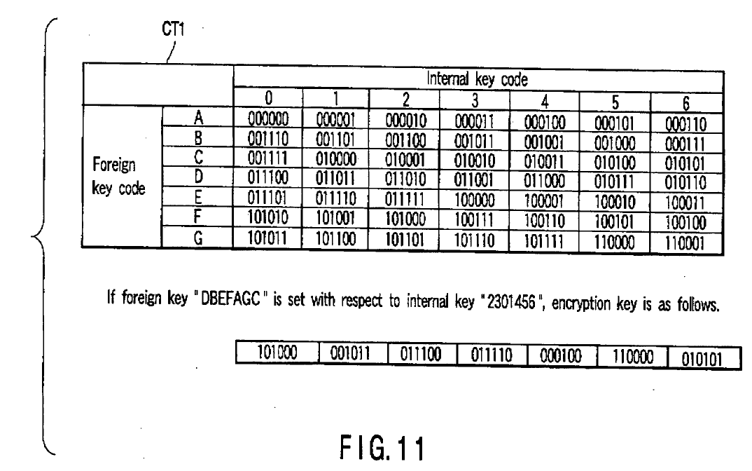

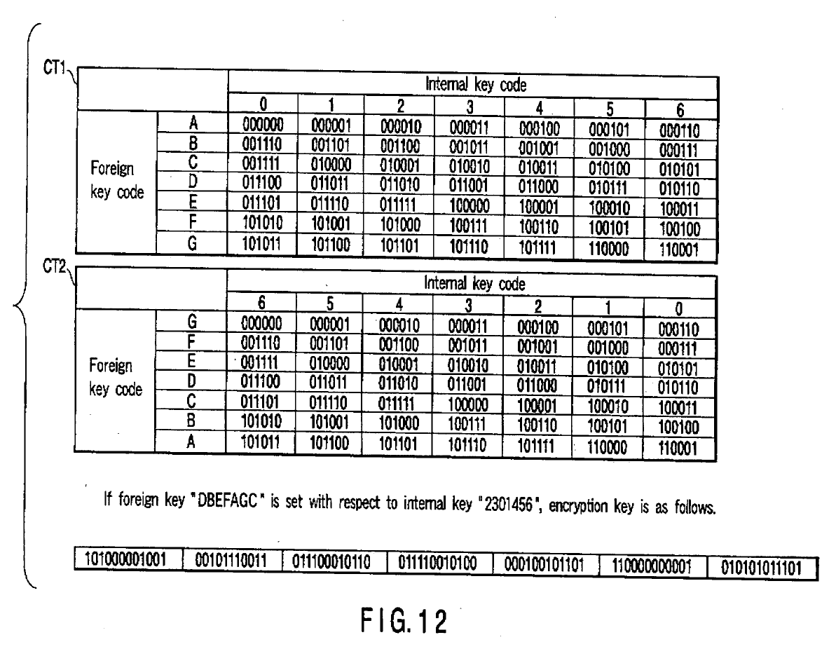

The method of generating internal and encryption keys will be explained below with reference to FIG. 11 and FIG. 12.

Keys actually used for encryption are generated in the apparatus in combination with the internal key and the encryption key. Two embodiments are given below as the method of generating internal and encryption keys. According to the examples, the combination of two kinds of keys are employed; in this case, even if three or more keys are used, the combination of keys is expanded. On the other hand, even if the original key for generating encryption key is one, the embodiments are applicable.

### First Embodiment of Generating a Key Used for Encryption

FIG. 11 shows a code table CT1. For example, the internal key is generated by combining numbers from “0” to “6”. On the other hand, the foreign key is generated by combining letters from “A” to “G”. As seen from the code table CT1 of FIG. 11, the numbers are arrayed in the column direction while the letters are arrayed in the row direction. A 6-digit arbitrary code is allocated to each intersected part of the matrix.

For example, the foreign key “DBEFAGC” is set with respect to the internal key data “2301456”. In this case, the internal key “2” and the foreign key “D” are collated with the code table. As a result, the position (2, D) where column and row corresponding to each value intersect with each other, that is, data “011010” is acquired. Likewise, the position (3, B), that is, data “001011” is acquired. Each data of positions (0, E), (1, F), (4, A), (5, G) and (6, C) is acquired in the same manner described above. These data are successively linked, thereby generating a new encryption key having the following data:
“011010 001011 011100 101001 00100 110000 010101”

Here, part of the internal and foreign keys is extracted, and then, reference to the table is made. In this case, the extraction is carried out at the unit of 1 bit. However, if the extraction size is too large, the reference table size also becomes larger; for this reason, the extraction should be carefully carried out.

### Second Embodiment of Generating a Key Used for Encryption

The second embodiment relates to the method of generating a more complicated encryption key. FIG. 12 shows the method of generate an encryption key in combination with two kinds of code tables. In FIG. 12, there are shown code tables CT1 and CT2. The code table CT1 is the same as shown in FIG. 11. The internal key has the array from “0” to “6” successively from the left; on the other hand, the foreign key has the array from “A” to “G” successively from top. On the contrary, according to the code table CT2, the internal key has the array from “6” to “0” successively from the left; on the other hand, the foreign key has the array from “G” to “A” successively from top. In this case, a 6-digit arbitrary code has the same array as the code table CT1.

For example, the foreign key “DBEFAGC” is set with respect to the internal key data “2301456”. First, data “101000” of the position (2, F) combining the internal key “2” and the foreign key “F” is extracted from the code table CT1. Concurrently, data “001001” of the position (2, F) combining the internal key “2” and the foreign key “F” is extracted from the code table CT2. The foregoing two data are linked, and thereby, a code “101000 001001” is generated,

Data is extracted from each code table, and thereafter, linked like the first embodiment, and thereby, the following code is finally obtained.
“101000001001 001011100111 011100010110 011110010100 000100101101 110000000001 010101011101”

In this case, data extracted from two code tables are only linked. However, the data extracted from each code table is linked after being divided into several, and thereby, it is possible to generate a more complicated encryption key.

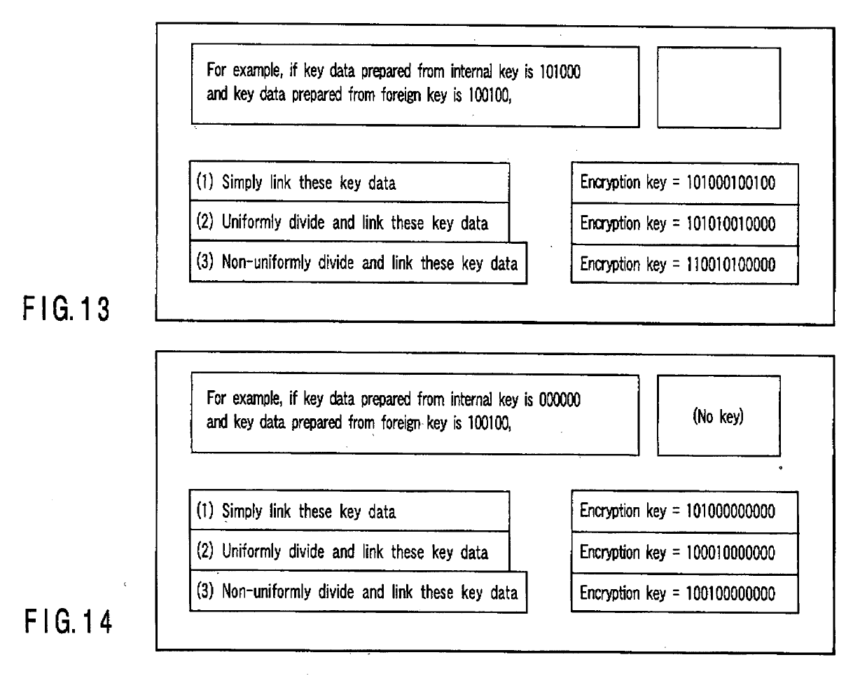

FIG. 13 shows an example in which data extracted from each of internal and foreign key tables are divided and linked to generate a more complicated encryption key. For example, (code) data extracted from the internal key table is “101000”, and data extracted from the foreign key table is “100100”. If the foregoing two data are simply linked (case 1), an encryption key “101000100100” is obtained. If these data are uniformly divided and linked (case 2), an encryption key “101010010000” is obtained. If these data are uniformly divided (case 2), an encryption key “110010100000” is obtained.

If encryption is carried out using only internal key when the encryption level is level 1, an encryption key is generated according to the method described below.

In FIG. 14, if no foreign key is set with respect to data “2301456” generated from the internal key, a predetermined value (e.g., “000000”) is used in place of the foreign key. The data is simply linked, and once divided and linked according to regularity, thereby obtaining a complicated encryption key.

More specifically, data generated from the internal key is “101000”. If these data are simply linked (case 1), an encryption key “101000000000” is obtained. If these data are uniformly divided and linked (case 2), an encryption key “100010000000” is obtained. If these data are non-uniformly divided (case 2), an encryption key “100100000000” is obtained.

Incidentally, according to the method of generating an encryption key, if the internal and foreign keys have the same value, the same encryption key is necessarily generated. The encryption key is not permanently held in the apparatus, but generated for each JOB, and abandoned at the same time when the JOB ends.

Reference to table is made using ID and password like the method of generating an encryption key, and thereby, an internal key is generated. The internal key is generated for each JOB, and abandoned at the same time when the JOB ends.

The code size of the finally generated encryption key must be within a range usable in the encryption device 23 and the decryption device 24. For this reason, the code table data used in FIG. 11 and FIG. 12 must be prepared taking the specification of the foregoing encryption and decryption devices 23 and 24 into consideration.

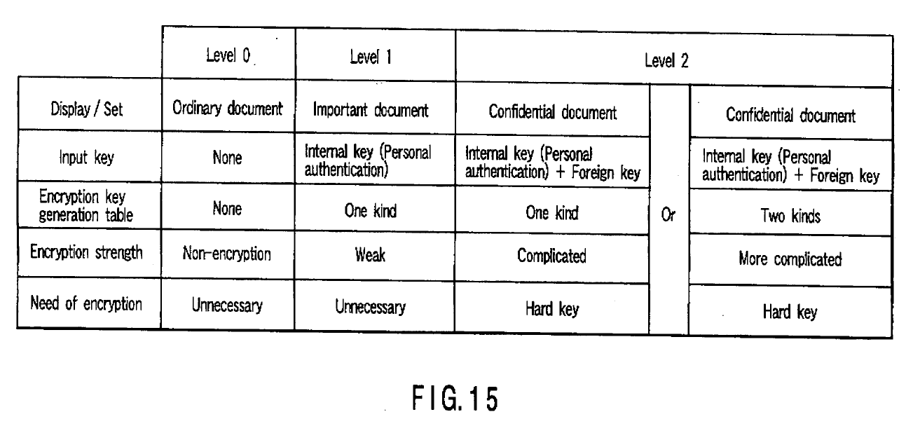

FIG. 15 is a table showing various functions relevant to encryption (cipher?) of the apparatus of the present invention. In the table of FIG. 15, encryption levels 0, 1 and 2 are shown in order in the traverse direction of the top column. The encryption level 0 corresponds to “Ordinary document”. The encryption level 1 corresponds to “Important document”. The encryption level 2 corresponds to “Confidential document”. The encryption level 0 corresponds to “None” of input key. The encryption level 1 corresponds to “Internal key (for personal authentication)”. The encryption level 2 corresponds to “Internal key (for personal authentication) and foreign key”.

In the encryption key generation table (described in FIG. 11 and FIG. 12), “None” of encryption keys is used in the encryption level 0. “One kind” of encryption keys is used in the encryption level 1. “One or two kinds” of encryption keys are used in the encryption level 2. The encryption strength of each level is as follows. The encryption level 0 is “No encryption”, the encryption level 1 is “weak”, and the encryption level 2 is “complicated”. The use of the foreign key in each level is as follows. The foreign key is “unnecessary” in the encryption levels 0 and 1, and “hard key” is necessary in the encryption level 2.

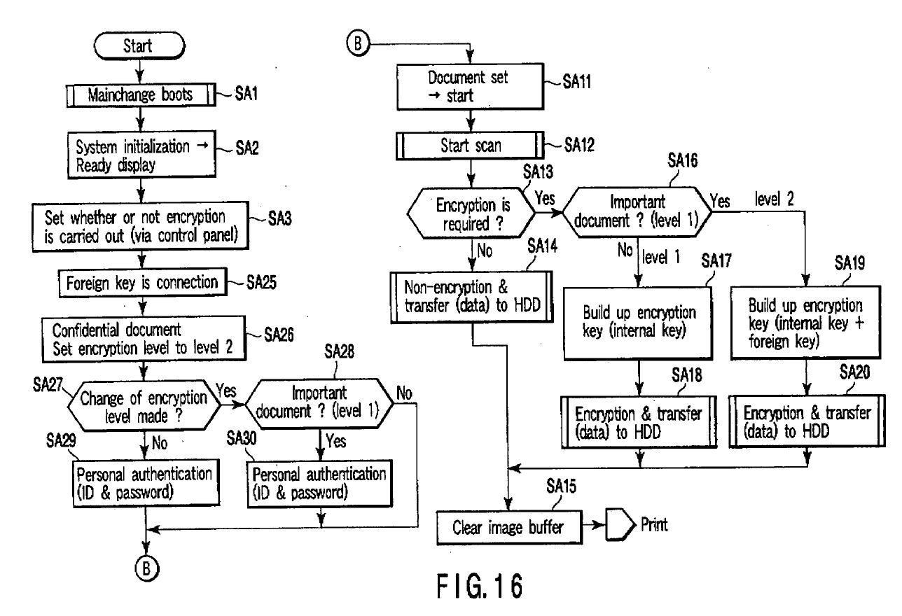

FIG. 16 is a flowchart to explain another embodiment different from the embodiment described in FIG. 6. The embodiment shows the procedure of the case where a foreign key is used to read a document. More specifically, the foreign key is used only when the encryption level is level 2 in the present embodiment. Thus, if the foreign key is previously inserted, the encryption level is automatically set to “Level 2” when the foreign key is detected. In FIG. 16, the same reference numerals are used to designate steps corresponding to the embodiment described in FIG. 6. When it is determined in step SA3 whether or not encryption is carried out, a connection state of the foreign key is detected (step SA25). Then, the encryption level is set to level 2 (Step SA26). In this case, it is determined whether or not a change of the encryption level is made (step SA27). If no change is made, the procedure for personal authentication is taken (step SA29), and thereafter, the control flow transfers to step SA11. If the change of the encryption level is made, it is determined which the encryption level is level 1 or 0 (step SA28). If the encryption level is level 1, the procedure for personal authentication is taken in step SA30, and thereafter, the control flow transfers to step SA11. If the encryption level is level 0, the control flow transfers to step SA11 without taking the procedure for personal authentication. Other steps are the same as FIG. 6; therefore, the explanation is omitted.

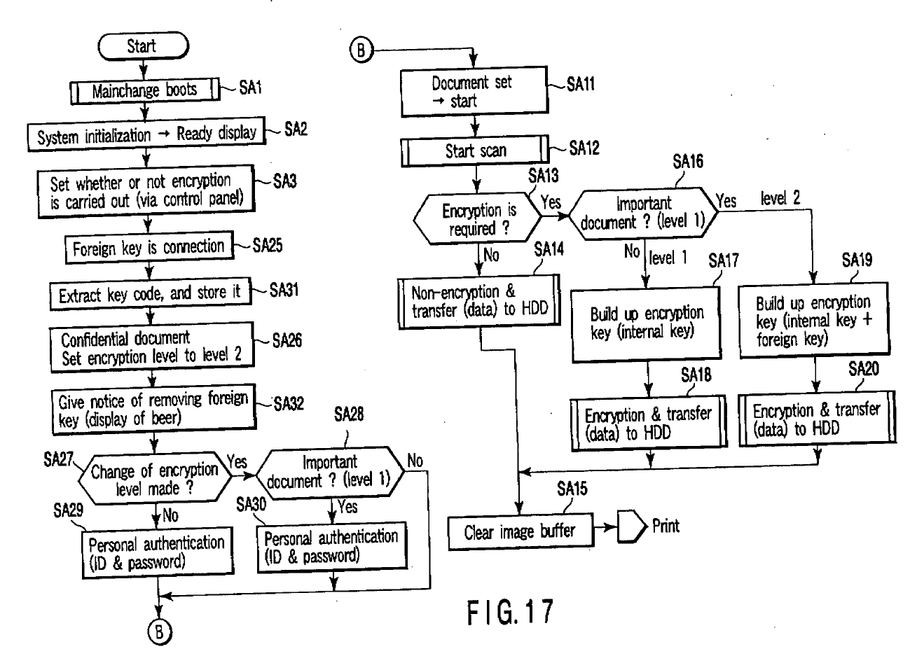

FIG. 17 is a flowchart to explain still another embodiment different from the embodiment described in FIG. 6. In FIG. 17, the same reference numerals are used to designate steps corresponding to the embodiment described in FIG. 6. As seen from the flowchart of the embodiment of FIG. 17, a foreign key is loaded (step SA25), and thereafter, a key code is extracted from the foreign key before scanning a document, and then, stored in the apparatus (step SA31). The encryption level is set to level 2, and then, a beeper sounds (step SA32) to give notice that the removal of the foreign key is possible. By doing so, the user can securely store and manage the foreign key.

The present invention effective features described below.

(1) Super-ordinate concept:

(1-1) According to the present invention, the encryption strength is set to several levels, that is, two levels or more.

(1-2) A change of the encryption level is possible using several keys.

(1-3) One of keys necessary for encryption functions as data for taking the procedure for personal authentication.

(1-4) User can freely change the encryption level in accordance with confidentiality.

(1-5) Encryption is carried out using the virtual disk drive on RAM, and the RAM is cleared after JOB is completed.

(1-6) Encryption keys are generated using hardware, and prepared for each JOB, and abandoned after the JOB ends.

(1-7) Therefore, the encryption strength is freely set in accordance with the content of the document. The encryption key is prepared for each JOB, and erased after the JOB ends, thereby preventing leakage of key information. The encryption strength is set stronger, and thereby, the reduction of process speed is predicted. However, several encryption levels are provided, and thereby, the user can freely select the encryption level giving priority to which of process time or confidentiality based on the balance of process speed, encryption strength and confidentiality of document. Thus, the encryption level select section is provided.

(1-8) When the printer is used, encryption is possible in print setting on PC. In this case, it is possible to input a key code for taking the procedure for personal authentication.

(1-9) Encryption is carried out using a key for taking the procedure for personal authentication when fetching print output. Therefore, it is impossible to fetch the print output without taking the procedure for personal authentication.

(1-10) Therefore, even if the apparatus is used as a printer, it is possible to set encryption, and to prevent the print output from being seen or stolen by the third party before the output result is acquired.

(1-11) Encryption is carried out using the virtual disk drive comprising volatile RAM without using HDD. A section for using the virtual disk drive is provided.

(1-12) When carrying out processing including storage to the apparatus, encrypted data is stored in HDD. In this case, the encrypted data is stored at high encryption level only

(1-13) Even if the apparatus is stolen to extract data stored therein, data stored in the virtual disk drive is erased when the apparatus powers off. Therefore, it is possible to prevent leakage of information.

(2) Medium concept:

(2-1) According to the present invention, the encryption strength is set to several levels, that is, two levels or more including non-encryption.

(2-2) Two keys or more are combined in accordance with the encryption strength, and thereby, a level change is possible. The apparatus of the present invention is provided with a level change section.

(2-3) User can freely set the encryption level in accordance with copy and confidentiality of documents to be printed. The apparatus of the present invention is provided with an encryption level setting section.

(2-4) One of keys necessary for encryption functions as data for taking the procedure for personal authentication.

(2-5) ID number and password must be previously registered as data for taking the procedure for personal authentication. Thus, the apparatus of the present invention is provided with a registration section.

(2-6) User can freely set the ID number. The is apparatus of the present invention is provided with a re-input instruction section, which makes collation with the ID set in registration, and urges the user to input ID once more if the same ID exists.

(2-7) ID and password for each user are encrypted using a key generated in the apparatus, and stored in a place incapable of making reference from the outside.

(2-8) Therefore, the encryption strength is changeable in accordance with confidentiality of document. Several keys are used, and thereby, it is difficult to decrypt data if the worst should happen as compared with encryption using only single key. The encryption strength is set stronger, and thereby, the reduction of process speed is predicted. In order to solve the problem, several encryption levels are provided. As a result, the user can freely select the encryption level giving priority to which of process time or confidentiality based on the balance of signal processing speed, encryption strength and confidentiality of document. In addition, it is possible to set non-encryption, and thereby, ordinary documents can be copied and printed out according to the procedure taken as usually. Therefore, it is possible to secure the same operability as the conventional case.

(2-9) When the printer is used, password is set in printer setting on PC.

(2-10) When fetching print output, password and authentication code for specifying individual are input, and thereby, access to print queue is possible. As a result, printout is possible (the printout is not permitted if the procedure for personal authentication is not taken).

(2-11) Therefore, encryption is set when the printer is used. As a result, higher security is obtained as compared with the conventional private print.

(2-12) When encryption is carried out, data is stored using the virtual disk drive on RAM, and the used RAM area is cleared after JOB is completed.

(2-13) Encryption (cipher?) keys used for encryption is cleared not to be left after JOB ends.

(2-14) Used buffers are cleared after JOB ends, and thereby; stored data is erased.

(2-15) Encryption key is prepared for each JOB, and abandoned after the JOB ends.

(2-16) The encryption key is not stored in the machine after JOB ends; therefore, there is no leakage of the encryption key. Even if the apparatus is stolen to extract data stored therein, data stored in the virtual disk drive is erased when the apparatus powers off. Therefore, it is possible to prevent leakage of information.

(3) Sub-ordinate concept:

(3-1) According to the present invention, the encryption level is set to three levels, that is, confidential document (level 2), important document (level 1) and ordinary document (level 0).

(3-2) The document set as the confidential document (level 2) is encrypted using dedicated key code from the outside in addition to encryption (cipher?) key held in the machine in scanning document.

(3-3) Internal keys stored in the machine must be previously registered having ID number and password.

(3-4) Internal keys held in the machine functions as an authentication key for identifying an individual

(3-5) In the confidential document (level 2), a display of requesting the input of foreign key is made, and user is urged to load the foreign key in copy start. In the confidential document (level 2), it is impossible to carry out copy/print without using the foreign key.

(3-6) If the important document (level 1) is set, encryption is carried out using keys held in the machine without using the foreign key.

(3-7) If the ordinary document (level 0) is set, no encryption is carried out (operation as usual).

(3-8) ID number is freely set for each person. In registration, collation with the already set ID number is made, and if the same ID exists, user is urged to input ID once more.

(3-9) In authentication, personal information (ID/password) stored in the apparatus is decrypted and collated using encryption (cipher?) key prepared based on ID and password input via the control panel.

(3-10) If a storage function is specified, data is stored in the hard disk drive without using volatile memory. In this case, the applicable encryption level is level 2 only.

(3-11) Therefore, the encryption strength is changed into three levels in accordance with confidentiality of document. Two keys are used, and thereby, if the worst should happen, data security is improved as compared with encryption using only single key. If the encryption strength is set stronger, the reduction of process speed is predicted. In order to solve the problem, several encryption levels are provided. As a result, the user can freely select the encryption level giving priority to which of process time or confidentiality based on the balance of processing speed, encryption strength and confidentiality of document. In addition, it is possible to set non-encryption, and thereby, ordinary documents can be copied and printed out according to the procedure taken as usually. Therefore, it is possible to secure the same operability as the conventional case.

One of two kinds of keys is different for each user. By doing so, it is possible to use the key as data for taking the procedure for personal authentication, and thus, to reduce damage by leakage to the minimum.

(3-12) In print from personal computer, security level is set in printing via the printer.

(3-13) If encryption level is set in printing via the printer, data is transferred from the personal computer, and thereafter, data is encrypted and stored in accordance with the security level.

(3-14) When fetching printout, the printout is fetched using the foreign key in addition to personal authentication in accordance with the encryption level.

(3-15) As the consequence, it is possible to set the encryption when the printer is used, and the secured security is obtained rather than the conventional system.

(3-16) When encryption is carried out, encrypted data is stored in the virtual disk drive using volatile memory, and the virtual disk drive is cleared after JOB ends, thereby preventing leakage.

(3-17) The encryption key is cleared by depressing a clear key on the control panel or auto-clear timer after JOB ends.

(3-18) Internal keys are generated using ID number and password previously registered for each JOB, and when the JOB ends, erased at the same timing as erasing the encryption key.

(3-19) ID and password for each user are encrypted using keys prepared in the apparatus, and stored in the place incapable of making reference from the outside of the apparatus.

(3-20) The encryption key is not held in the machine after the JOB ends; therefore, there is no leakage of the encryption key. Personal information, that is, ID and password are encrypted and stored using encryption keys prepared in the apparatus. Therefore, measures for preventing leakage of personal information are sufficiently taken.

What is claimed is:

1. An encrypting apparatus for an image processing apparatus, comprising:
a reader reading an image;
a read image processing circuit processing the read image;
a printer carrying out print to media;
a print image processing circuit carrying out print image processing for print;
a buffer memory used for image data processing;
an encryption device encrypting the image data input to the buffer memory;
a storage device storing the encrypted image data;
a decryption device decrypting the encrypted image data;
a foreign key detection circuit recognizing a hard key;
a control panel including a control panel for carrying out various settings by a user, and for inputting ID and password for taking a procedure for personal authentication;
a main controller collectively controlling the foregoing reader, read image processing circuit, printer, print image processing circuit, buffer memory, encryption device, decryption device, foreign key detection circuit and control panel; and
an encryption key and level controller setting an encryption strength to arbitrary one level of two or more several levels when the encryption device encrypts the image data.

2. The apparatus according to claim 1, wherein the encryption key and level controller includes a storage storing several keys, and has an encryption level change section, which changes the encryption level when a key is selected.

3. The apparatus according to claim 1, wherein the encryption key and level controller further includes an encryption level variable section, which freely changes the encryption level when a user instructs to change the encryption level via the control panel in accordance with confidentiality.

4. The apparatus according to claim 1, wherein the encryption key and level controller further includes a stored data clear section, which uses a virtual disk drive on random access memory (RAM) while clearing data stored in the RAM after-a job ends when encryption is carried out.

5. The apparatus according to claim 1, wherein the encryption key and level controller further includes a print output section, which uses an internal key for fetching printout, and generates the internal key to obtain the printout if personal authentication is normal when print by the printer is carried out.

6. The apparatus according to claim 1, wherein the encryption key and level controller further includes:
a virtual disk drive use section, which uses a virtual disk drive comprising volatile RAM without a hard disk drive (HDD) when encryption is carried out; and,
a encryption strength setting section, which stores encrypted data in the HDD while setting a encryption level strength to level having high encryption level when storage to the apparatus is carried out.

7. The apparatus according to claim 1, wherein the encryption key and level controller further includes a level change section, which changes a level by combining two or more keys in accordance with an encryption strength including non-encryption.

8. The apparatus according to claim 1, wherein the encryption key and level controller includes one of keys necessary for encryption, which functions as data for taking a procedure for personal authentication.

9. The apparatus according to claim 1, wherein the encryption key and level controller further includes a password registration section, which previously registers ID number and password as data for taking a procedure for personal authentication.

10. The apparatus according to claim 9, wherein the encryption key and level controller further includes a re-input instruction section, which makes collation with the set ID when the ID number is input, and urges the user to input ID one more if the same ID exists.

11. The apparatus according to claim 9, wherein the encryption key and level controller further includes a hold section, which encrypts ID and password for each user using a key prepared in the apparatus, and stores them in a memory incapable of making reference from the outside.

12. The apparatus according to claim 1, wherein the encryption key and level controller further includes a response section, which responds to encryption level instruction to an image data when printout by the printer is instructed by an operation from an external personal computer.

13. The apparatus according to claim 1, wherein the encryption key and level controller further includes:
a clear section for clearing the encryption key used for encryption after a job ends;
an erase section for clearing and erasing data stored in the used buffer memory after a job ends; and
an abandon section for preparing the encryption key for each job, and abandoning it after a job ends.

14. The apparatus according to claim 1, wherein the encryption key and level controller sets three encryption levels, that is, encryption level 2 used for confidential document, encryption level 1 used for important document and encryption level 0 used for ordinary document.

15. The apparatus according to claim 14, wherein the encryption key and level controller further includes an additional encryption section, which encrypts a document set as the encryption level 2 using a dedicated foreign key from the outside in addition to an encryption key held in the apparatus when scanning the document.

16. The apparatus according to claim 14, wherein the encryption key and level controller further includes a control section, which display a message requesting an input of a foreign key when copy starts in the encryption based on the encryption level 2 used for confidential document, and urges the user to load the foreign key so that copy and print are not carried out without using the foreign key.

17. The apparatus according to claim 14, wherein the encryption key and level controller further includes an encryption section, which carries out encryption using an internal key held in the apparatus without using a foreign key when the encryption level 1 used for important document is set.

18. An encrypting method for an image processing apparatus scanning a document to acquire an image data, encrypting the image data, and storing it in a memory, comprising the following steps of:
displaying several icons for queuing several encryption levels including non-encryption with respect to the image data on a control panel;
requesting ID input for personal authentication via the control panel when a first encryption level is selected from several icons; and
requesting to input ID for personal authentication and to input a foreign key via the control panel when a second encryption level is selected from several icons.

19. The method according to claim 18, further comprising the following steps of:
generating an encryption key using an internal key when a first encryption level is selected from several icons, and encrypting the image data using the encryption key;
generating an encryption key using internal and foreign keys when a second encryption level is selected from several icons, and encrypting the image data using the encryption key; and
storing encrypted image data in a volatile memory, and clearing data stored in the volatile memory after the stored image data is read.
